(19) United States
(12) Patent Application Publication
(10) Pub. No.: US 2007/0242606 A1
(43) Pub. Date: Oct. 18, 2007

(54) Dynamic reverse link overhead control based load information

(75) Inventor: Wanshi Chen, San Diego, CA (US)

Correspondence Address: COATS & BENNETT/ERICSSON WIRELESS COMM''S., INC., 1400 CRESCENT GREEN, SUITE 300, CARY, NC, 27518, US

(73) Assignee: Telefonaktiebolaget LM Ericsson (publ)

(21) Appl. No.: 11/404,426

(22) Filed: Apr. 14, 2006

(51) Int. Cl. H04J 1/16

(52) U.S. Cl. 370/235

(57) ABSTRACT

A method of controlling reverse link feedback in a mobile communication system comprises detecting reverse link load for at least one sector in the network; and dynamically updating a control setting for a reverse link control channel responsive to the detected load.

### BACKGROUND

In high data rate CDMA systems, such as 1×EV-DV, 1×EV-DO and WCDMA systems, the forward traffic channel is time-multiplexed and transmitted at the full power available to the sector, but with data rates and slot times that vary depending on downlink channel conditions. The data rate that can be supported by the downlink is proportional to the SNR, which changes continuously. The mobile terminals measure the instantaneous signal to noise ratio (SNR) of the pilot signal received from each sector in its active set and requests service from the access network providing the strongest signal. The mobile terminal 100 transmits the SNR value, or equivalently the supportable data rate, for the sector providing the strongest signal on a reverse control channel referred to generically as the rate control channel. In 1×EV-DO systems, the mobile terminal measures the SNR and transmits data rate requests to the serving sector on the Data Rate Channel (DRC). The mobile terminal applies a Walsh cover to the DRC to indicate its selection of a serving sector for forward link communications.

The access network designates a DRC information length denoted by the system variable DRC Length indicating a number of slots over which the DRC information is repeated and transmits the designated DRC information length to the access terminal. The mobile terminal transmits updated DRC information to the access network in every DRCLength slots. In general, fast channel feedback (low DRCLength) is beneficial for forward link operations. However, faster feedback implies higher overhead, which can negatively impact reverse link transmissions.

### SUMMARY

The present invention relates to a method implemented by an access network (also known as a base station) for controlling reverse link feedback in a mobile communication system. The access network determines reverse link load for at least one sector in the network, and dynamically adjusts a control setting for a reverse link control channel responsive to the detected load. In one exemplary embodiment, the access network monitors the reverse link load and adjusts the repetition frequency of a rate control channel. In 1×EV-DO systems according to the Telecommunications Industry Association (TIA) standard TIA-856A, for example, the repetition frequency of a Data Rate Channel (DRC) is dynamically adjusted based on reverse link load by adjusting the system variable DRCLength.

### BRIEF DESCRIPTION OF THE DRAWINGS

FIG. 1 is a block diagram of an exemplary mobile communication network.

FIG. 2 is a block diagram of an exemplary access network.

FIG. 3 is an exemplary procedure for adjusting a control setting for a reverse link control channel.

### DETAILED DESCRIPTION

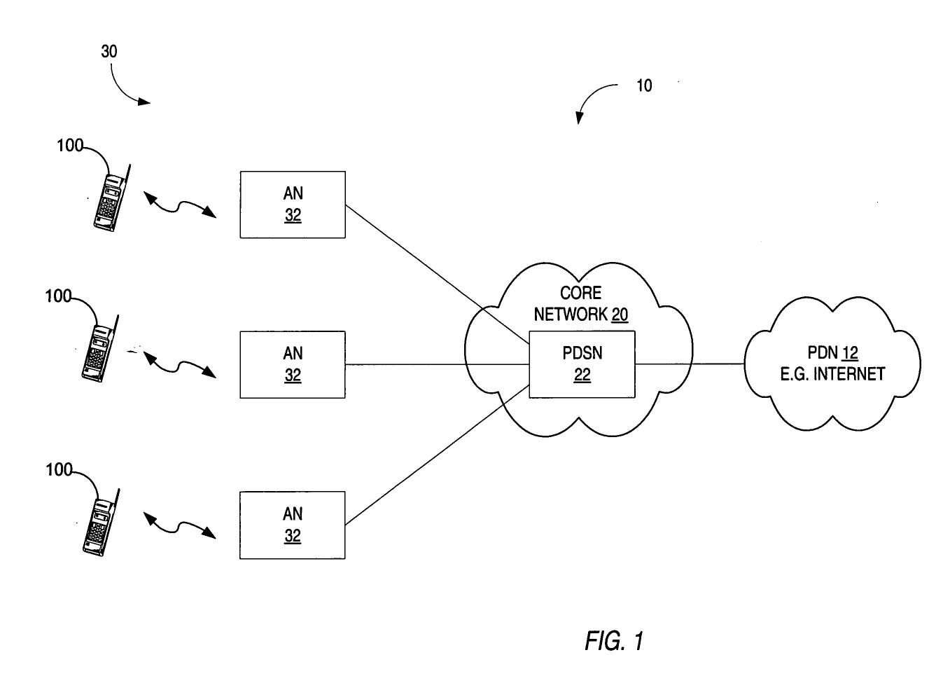

Referring now to the drawings, the present invention will be discussed in the context of an exemplary wireless communications network 10. FIG. 1 illustrates a CDMA network 10 according the TIA-856A standard, which is commonly known as 1×EV-DO. The network 10 comprises a core network (CN) 20 and a radio access network (RAN) including a plurality of access networks 32 providing services to one or more mobile terminals 100. The core network 20 includes a packet data serving node 22 that connects the access networks 32 to external Packet Data Networks (PDN) 12, such as the Internet. Each access network 32 is located in and provides wireless communication services to a geographic region referred to as a cell, which may comprise one or more sectors. In general, there is one access network 32 for each cell or sector. A single access network 32 may serve multiple sectors.

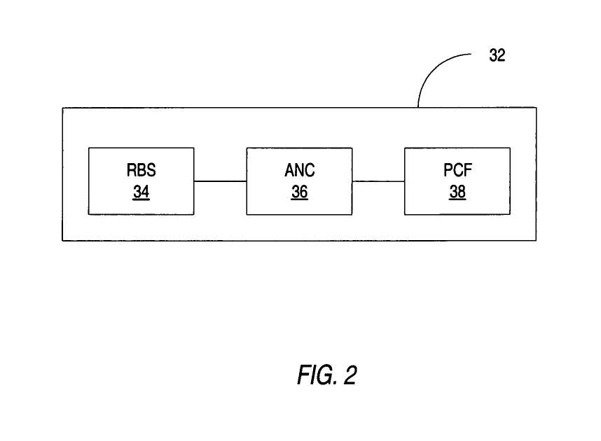

FIG. 2 illustrates an exemplary access network 32. The access network 32 comprises a radio base station (RBS) 34, an access network controller (ANC) 36, and a packet control function (PCF) 38. The RBS 34 comprises the radio equipment for communicating over the air interface with the mobile terminals 32. The ANC 36 controls operation of the access network 32 and the use of communication resources. The PCF 38 provides connection to the PDSN 22 in the core network 20.

In 1×EV-DO systems, packet data is transmitted on the forward link over a shared packet data channel called the Forward Traffic Channel (FTC). Packet data transmissions to different users are time multiplexed and transmitted at full power. Only one user in a sector receives transmissions from the access network 32 at a time. Due to the complexity of coordinating packet data transmissions between sectors, soft handoff is not used on the FTC channel. Instead, a process known as sector selection or sector switching is used. The mobile terminal 100 monitors the signal power from all sectors in its active set and selects the sector that provides the strongest signal as the serving sector. As the mobile terminal 100 moves away from the serving sector toward a non-serving sector, the signal strength from the serving sector will diminish while the signal strength from the non-serving sector will increase. When the signal strength from a candidate sector in the mobile terminal's active set exceeds the signal strength from the serving sector by a predetermined amount, the mobile terminal 100 sends a signal to the network 10 to switch sectors.

A virtual handoff or cell-switching occurs when the mobile terminal 100 switches from a serving sector belonging to a first access network 32 to a new serving sector belonging to a different access network 32. In this case, there may be a small delay in the delivery of packets to the mobile terminal 100 while the target sector prepares for communications with the mobile terminal 100. Many packet data applications are delay tolerant and the small delays due to cell switching may be acceptable for these applications. However, some packet data applications, such as voice-over IP, are delay intolerant and even small delays will negatively impact the perceived quality of the connection. Therefore, it is desirable to minimize delays in delivering packet data for these delay-sensitive applications when switching from a sector belonging to one access network 32 to a sector belonging to a different access network 32. To reduce such delays, the mobile terminal 100 may give an early indication of its intention to change cells by sending a signal to the access network.

The Data Rate Control (DRC) channel, Acknowledgement (ACK), and Data Source Control (DSC) channels on the reverse link support the forward traffic channel operation. The mobile terminal 100 informs the access network 32 of the supportable data rate on the FTC and the best serving sector for the mobile terminal 100 on the DRC channel. In 1×EV-DO systems, the mobile terminal 100 indicates the best serving sector by the Walsh cover applied to the DRC. The mobile terminal 100 informs the access network 12 whether transmitted packets have been correctly received on the ACK channel. The DSC channel is a new channel introduced to reduce delays in delivering packets during a virtual handoff. The mobile terminal 100 uses the DSC channel to indicate the data source, e.g. access network 32, responsible for delivering packets on the forward link. More particularly, the mobile terminal 100 gives an early indication of its intention to switch between sectors in different cells by the Walsh cover applied to the DSC channel. The DRC and DSC channels are repeated over a predetermined number of slots as indicated by the system variables DRCLength and DSCLength respectively.

In general, fast channel feedback is beneficial for forward link operations, particularly when channel conditions are changing rapidly. However, when the reverse link is heavily loaded, some mobile terminals 100 may be power limited and thus unable to close the reverse link. Consequently, some of the mobile terminals 100 may not be able to reliably transmit information to the access network 32 over the reverse link control channels. If the ACK and/or DRC channels are not reliably received, the efficiency of forward link transmissions over the FTC will be negatively impacted. Therefore, it is desirable to have a relatively slow channel feedback during periods when the sector is heavily loaded. When the reverse link is lightly loaded, however, fast feedback is possible without substantially affecting reverse link operation. A faster feedback implies a smaller DRCLength and DSCLength, while a slower feedback implies a larger DRCLength/DSCLength.

According to the present invention, the access network 32 monitors the reverse link load and adjusts DRCLength and DSCLength accordingly. Equivalently, the access network 32 could adjust the gain of the DRC and DSC channels relative to the pilot channel. The control variables DRCLength and DSCLength control the number of slots over which a DRC message or DSC message is repeated. A low DRCLength/DSCLength value corresponds to a fast channel feedback, while a large DRCLength/DSCLength corresponds to a slow channel feedback. In operation, the access network 32 gradually reduces DRCLength and/or DSCLength as system load decreases, and gradually increases DRCLength and/or DSCLength as system load increases.

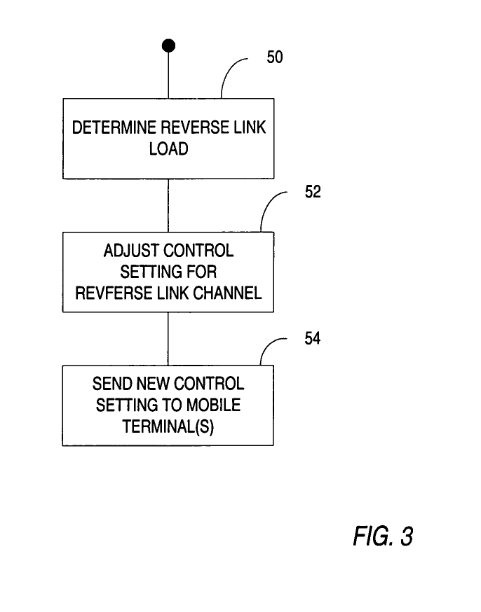

FIG. 3 is a flow diagram illustrating a procedure executed by the access network controller 36 to update DRCLength and/or DSCLength. The access network controller 36 determines the reverse link load (block 50). Measurement of the reverse link load can be done, for example, by measuring the rise over thermal (RoT). The access network controller 36 may use indirect measures of the load. For example, rate control commands generated by the access network controller 36 and/or the number of reverse link channels allocated can serve as an indirect measure of the load. In 1×EV-DO systems, for example, rate control commands or reverse activity bits (RABs) generated by rate control algorithms to control the data transmission rate on reverse link channels can be monitored. The RABs can be processed/filtered to generate a load indication. Performance parameters, such as sector/user throughput, delay, FER outage, ROT outage, etc., can be used as an indirect measure of the reverse link load.

Once the reverse link load is determined, the access network controller 36 uses the load information to update DRCLength and/or DSCLength (block 52). DRCLength and/or DSCLength can be updated on a per sector basis using load information for each sector. Alternatively, the access network controller 36 may aggregate load information for a plurality of sectors and use the aggregate load information to update DRCLength and/or DSCLength for all sectors.

In some embodiments, the same DRCLength/DSCLength may be used for all mobile terminals 100 within a sector. In this case, DRCLength and/or DSCLength may be transmitted over a broadcast channel to the mobile terminals 100 within the sector. In other embodiments, DRCLength and/or DSCLength may be adjusted for individual mobile terminals 100 or groups of mobile terminals 100. Adjusting DRCLength and/or DSCLength for individual mobile terminals 100 and/or groups of mobile terminals 100 allows the access network controller 36 to take into account other criteria such as the relative priority assigned to individual mobile terminals 100 or groups of mobile terminals 100, QoS requirements, and/or channel conditions. For example, different classes of users or different types of applications may be assigned different priority levels that affect the DRC/DSCLength. For delay tolerant applications, a large DRCLength and/or DSCLength may be acceptable. Delay-sensitive applications may require a shorter DRC/DSCLength. As another example, channel conditions may be used in addition to the load information to adjust DRCLength and/or DSCLength. Slow channel feedback may suffice for a stationary mobile terminal 100 with relatively stable channel conditions. On the other hand, when the mobile terminal 100 is moving, the channel may be changing rapidly. In this situation, fast channel feedback may be more desirable.

After updating DRCLength/DSCLength, the access network controller 36 controls the radio base station to send the DRCLength and/or DSCLength to one or more mobile terminals 100 (block 54). In embodiments where the same DRCLength/DSCLength is used for all mobile terminals 100, the access network 32 can send the updated DRCLength/DSCLength over a broadcast channel. In embodiments where the DRCLength and/or DSCLength is separately controlled for individual mobile terminals 100 or groups of mobile terminals 100, the updated DRCLength/DSCLength can be transmitted over a dedicated control channel. One simple and straightforward implementation is to send the new DRCLength/DSCLength to a mobile terminal 100 within a traffic channel assignment (TCA) message when the mobile terminal 100 performs a soft handoff in the reverse link.

The basic inventive concept of using load information to control channel feedback over a reverse link control channel can be easily extended to other standards, such as 1×EV-DV and WCDMA.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of controlling reverse link feedback in a mobile communication system, said method comprising:
detecting reverse link load for at least one sector;
dynamically adjusting a control setting for a reverse link control channel responsive to the detected load to control channel feedback from one or more mobile terminals; and
sending said control setting to at least one mobile terminal.

2. The method of claim of claim 1 wherein said control setting determines the reporting frequency for a data rate control channel.

3. The method of claim 1 wherein detecting reverse link load comprises measuring rise-over-thermal.

4. The method of claim 1 detecting reverse link load comprises monitoring a reverse activity indicator.

5. The method of claim 1 detecting reverse link load comprises monitoring the number of reverse link channels allocated.

6. The method of claim 1 detecting reverse link load comprises monitoring an admission control statistic.

7. The method of claim 1 detecting reverse link load comprises monitoring a QoS parameter.

8. The method of claim 7 wherein the QoS parameter comprises at least one of throughput, delay, frame error rate, or outage rate.

9. The method of claim 1 wherein detecting reverse link load comprises aggregating load information for two or more sectors.

10. The method of claim 9 wherein said control setting is dynamically adjusted based on said aggregate load information.

11. The method of claim 1 wherein mobile communication system comprises a mobile communication system operating according to TIA-856A.

12. The method of claim 11 wherein dynamically adjusting a control setting for a reverse link control channel comprises dynamically adjusting the DRCLength and/or DSCLength parameters specified by TIA-856A.

13. The method of claim 1 wherein said adjustment of said control setting is further based on channel conditions.

14. The method of claim 1 wherein said adjustment of said control setting is further based on QoS requirements.

15. The method of claim 1 wherein said adjustment of said control setting is further based on priority level.

16. An access network for a mobile communication system, said access network comprising:
an access network controller configured to detect a reverse link load and to dynamically adjust a control setting for a reverse link control channel responsive to the detected load; and
a radio base station to transmit packet data to a plurality of mobile terminals over a shared forward traffic channel and to receive control information from said mobile terminals over one or more reverse link control channels, said radio base station responsive to said access network controller to communicate said control setting to at least one mobile terminal.

17. The access network of claim 16 wherein said control setting determines the update frequency for a rate control channel.

18. The access network of claim 16 wherein said access network controller determines reverse link load by measuring rise-over-thermal.

19. The access network of claim 16 wherein said access network controller determines reverse link load by monitoring a reverse activity indicator.

20. The access network of claim 16 wherein said access network controller determines reverse link load by monitoring the number of reverse link channels allocated.

21. The access network of claim 16 wherein said access network controller determines reverse link load by monitoring an admission control statistic.

22. The access network of claim 16 wherein said access network controller determines reverse link load by monitoring a QoS parameter.

23. The access network of claim 22 wherein the QoS parameter comprises at least one of throughput, delay, frame error rate, or outage rate.

24. The access network of claim 16 wherein said access network controller aggregates load information for two or more sectors, and uses said aggregate load information to adjust said control setting.

25. The access network of claim 16 wherein the mobile communication system operates according to TIA-856A.

26. The access network of claim 25 wherein the access network controller dynamically adjusts the DRCLength and/or DSCLength parameters specified by TIA-856A.

27. The access network of claim of claim 16 wherein said access network controller further adjusts said control setting accounts based on channel conditions.

28. The access network of claim of claim 16 wherein said access network controller further adjusts said control setting accounts based on QoS requirements.

29. The access network of claim of claim 16 wherein said access network controller further adjusts said control setting accounts based on priority level.
